(19) United States
(12) Patent Application Publication
(10) Pub. No.: US 2018/0300444 A1
(43) Pub. Date: Oct. 18, 2018

(54) METHOD AND APPARATUS FOR FAN SIMULATION THROUGH FLOW ANALYSIS

(71) Applicant: CEDIC CO., LTD., Seoul (KR)

(72) Inventors: Jang-Hyung CHO, Goyang-si, Gyeonggi-do (KR); Wan-Ho JEON, Incheon (KR); Jun-Churl PARK, Gwangmyeong-si, Gyeonggi-do (KR)

(73) Assignee: CEDIC CO., LTD., Seoul (KR)

(21) Appl. No.: 15/768,889

(22) PCT Filed: Apr. 28, 2016
(86) PCT No.: PCT/KR2016/004442

§ 371 Date: Apr. 17, 2018

(51) Int. Cl. G06F 17/50; G01N 29/14

(52) U.S. Cl. CPC G06F 17/5086; G06F 17/5009; G01N 2291/02836; G01N 2291/011; G01N 29/14

(57) ABSTRACT

According to an embodiment of the present disclosure, a method for a fan simulation through flow analysis includes the steps of: inputting point data and tester dimensions by a user; generating a shape of a fan by calculating the point data, and generating a tester from the tester dimensions; generating grids on the fan; analyzing a flow generated by the fan by inputting boundary conditions for the fan; and calculating a noise index from the analysis, wherein, when the flow generated by the fan is in a steady state, the noise index is proportional to a pressure deviation depending on a location of the fan.

### TECHNICAL FIELD

The present disclosure relates to a method and apparatus for a fan simulation and, more particularly, to a method and apparatus for a fan simulation through flow analysis and noise analysis.

### BACKGROUND ART

Having been developed for the sake of improved function since industrialization, products are being turned into merchandise having higher quality and performance, following consumer demand for quality enhancement. One of the most important criterion to determine higher quality products is to provide a necessary flow work (air power) with minimal noise.

To give an example, a process for lowering a noise requires research on flow noise, and the research proceeds with an experimental study using a costly experimental facility including a so-called anechoic wind tunnel or anechoic fan tester having an anechoic room in a wind tunnel blowing a wind. Because this method is expensive and needs expertise, it is impossible for small and medium-sized businesses to perform research aiming at the production of higher quality products to which a low noise design is applied.

Particularly, an anechoic wind tunnel facility is so expensive that household electrical appliance companies and small and medium-sized businesses cannot afford to apply a technology requiring use of such an expensive facility. A development process through the experimental study is a repetitive task of, first, manufacturing a low noise shape (prototype manufacturing), executing an experiment in a situation similar to actuality with respect to the shape, and executing an experiment with a shape manufactured differently when an objective is not achieved. In the case of an automobile, it is a high cost and low efficiency structure such that, for a low noise shape, scores of automobiles each costing over several hundred thousand dollars should be manufactured and tested. In addition, research funds of several hundred thousand dollars are also required for research on household electrical appliances. Accordingly, the research on lowering noise is performed by a very limited number of major companies. Consequentially, a research process with a low cost and high efficiency that is able to replace the high cost and low efficiency research process is necessary.

### DISCLOSURE

### Technical Problem

The objective of the present disclosure is to provide a method and apparatus for a fan simulation which is capable of estimating performance of a fan through flow analysis.

Other objectives of the present disclosure will be more clearly understood through detailed description below and accompanying drawings.

### Technical Solution

According to an embodiment of the present disclosure, a method for a fan simulation through flow analysis includes: inputting necessary flow work by a user; confirming a basic shape provided by the present disclosure to generate such flow work; generating point data to map such a basic shape; generating a shape of the fan by calculating the point data; generating grids for an analysis appropriate for the fan; analyzing a flow generated by the fan by inputting boundary conditions for the fan; calculating efficiency and noise of the fan from the analysis, wherein the noise represents quantitative noise having a unit of dB or dBA or a noise index which is a relative value of the quantitative noise, and, when the flow generated by the fan is in a steady state, the noise index is proportional to a pressure deviation depending on a location of the fan.

When the flow generated by the fan is in an abnormal state, the noise index may be proportional to a pressure deviation at a predetermined location of the fan.

The analyzing the flow may include calculating pressure and velocity for the flow depending on the location of the fan and time.

According to an embodiment of the present disclosure, an apparatus for a fan simulation through flow analysis includes: a fan design module to which point data and tester dimensions are input; a CAD module generating a shape of a fan by calculating the point data input to the fan design module, and generating a tester from the tester dimensions; a grid module generating grids on the fan; a solving module analyzing a flow generated by the fan by inputting boundary conditions for the fan; and a performance analysis module calculating a noise index from the analysis, wherein, when the flow generated by the fan is in a steady state, the performance analysis module calculates the noise index proportionately to a pressure deviation depending on a location of the fan.

The solving module may calculate pressure and velocity for the flow depending on the location of the fan and time.

When the flow generated by the fan is in an abnormal state, the performance analysis module may calculate the noise index proportionately to a pressure deviation at a predetermined location of the fan.

### Advantageous Effects

According to an embodiment of the present disclosure, performance, that is efficiency and noise of a fan may be estimated by a fan simulation through flow analysis.

### DESCRIPTION OF DRAWINGS

FIG. 1 illustrates an anechoic wind tunnel and an anechoic fan tester.

FIGS. 2 and 3 are conceptual diagrams according to an embodiment of the present disclosure.

FIG. 4 illustrates a GUI according to an embodiment of the present disclosure.

FIG. 5 illustrates an input window for dimensions of a fan and a tester.

FIG. 6 illustrates dimensions of a ring and a hub and a rotating zone.

FIG. 7 illustrates dimensions of a shroud, a motor, a radiator, and a condenser

FIG. 8 illustrates dimensions of a shroud and a tester.

FIG. 9 illustrates an example generating an octree.

FIGS. 10 and 11 illustrate results of grids generated with the octree illustrated in FIG. 9.

FIG. 12 illustrates result images to make a report after completion of analysis.

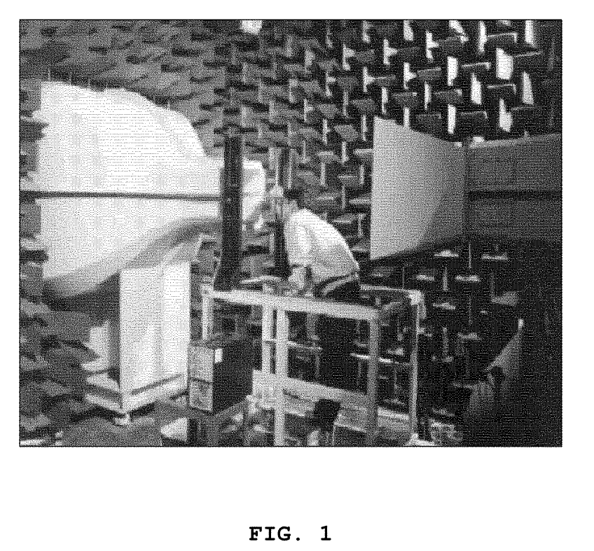

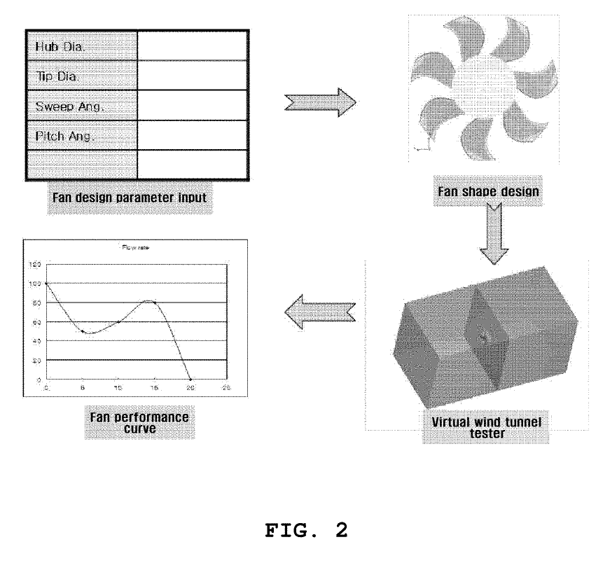

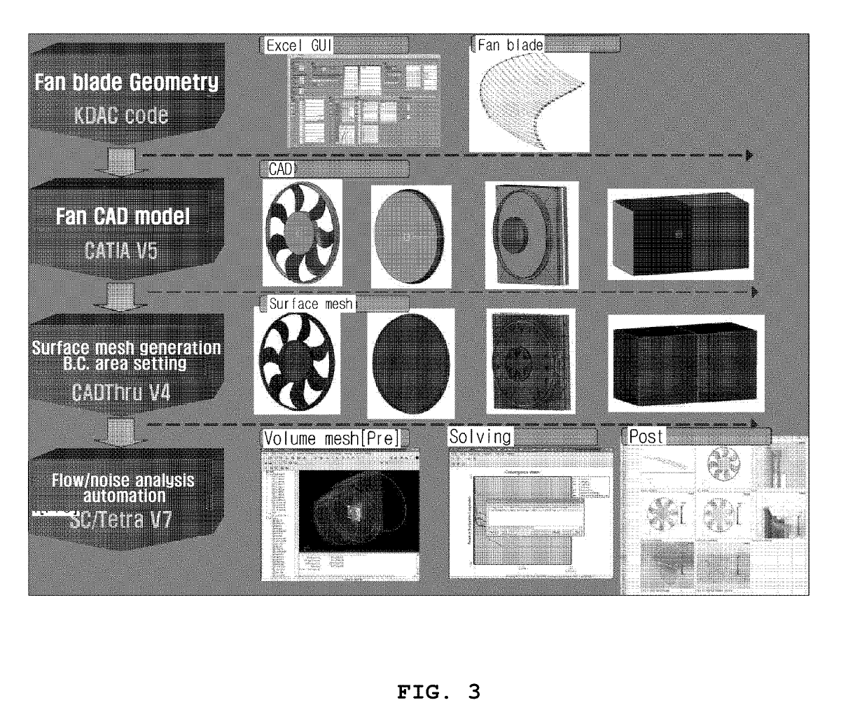

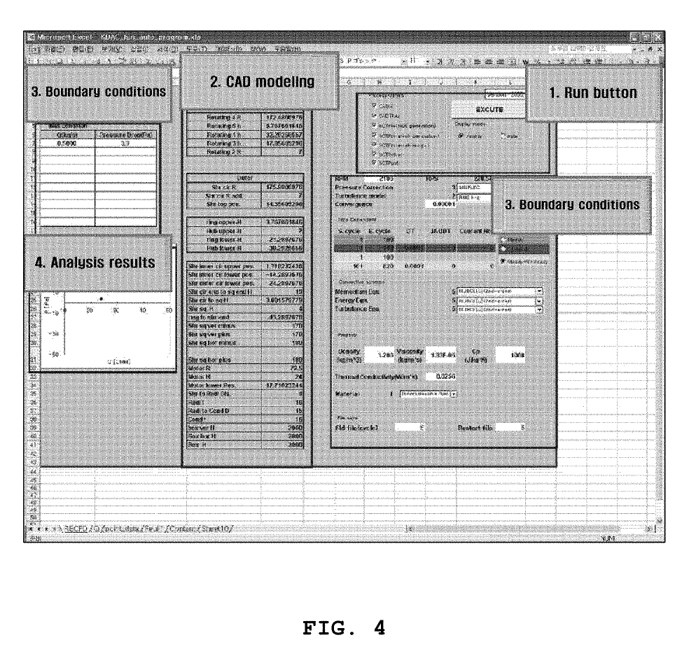

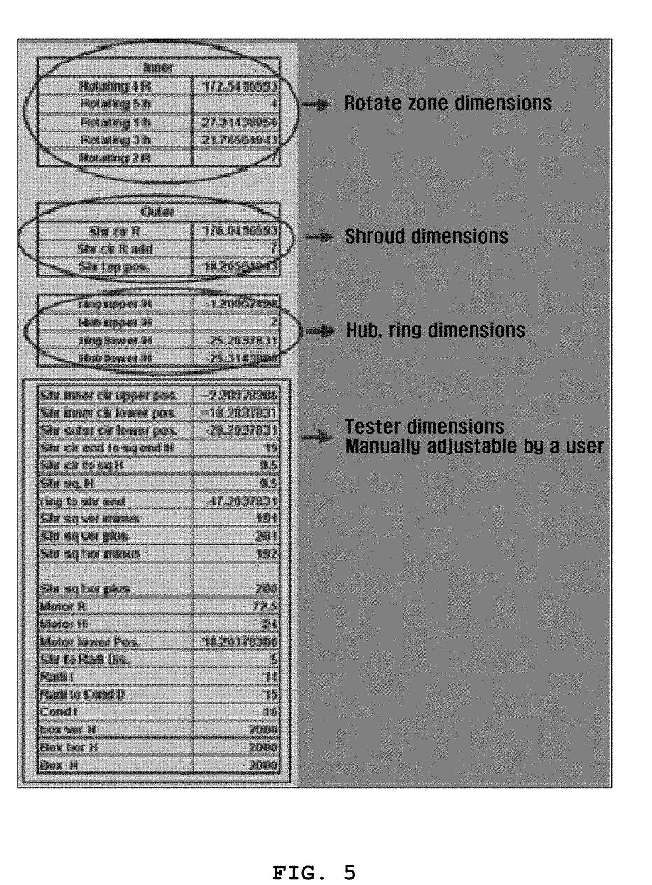

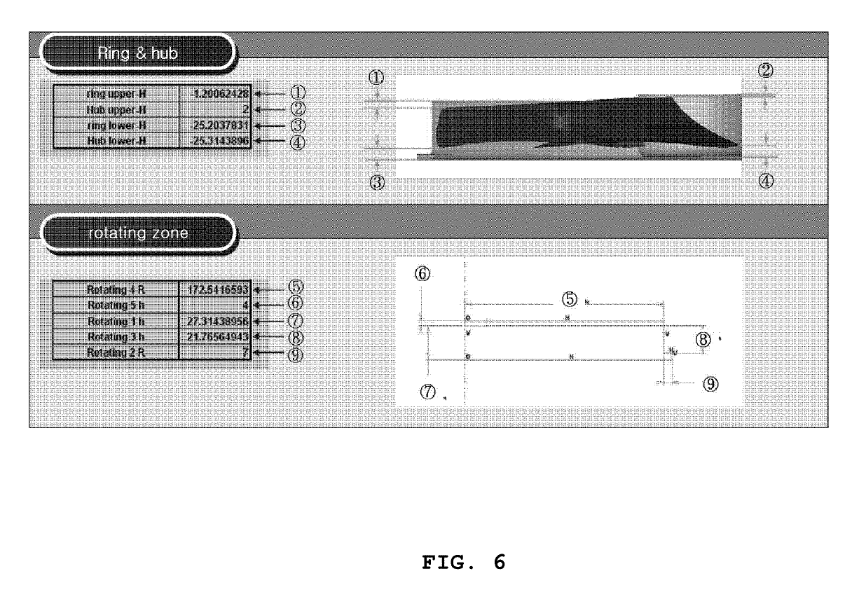

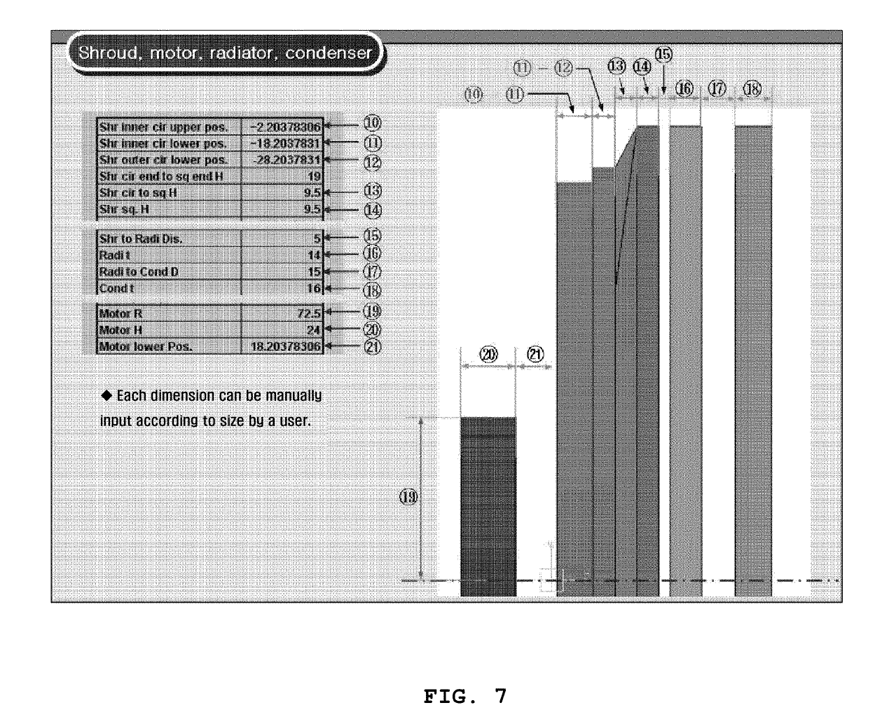

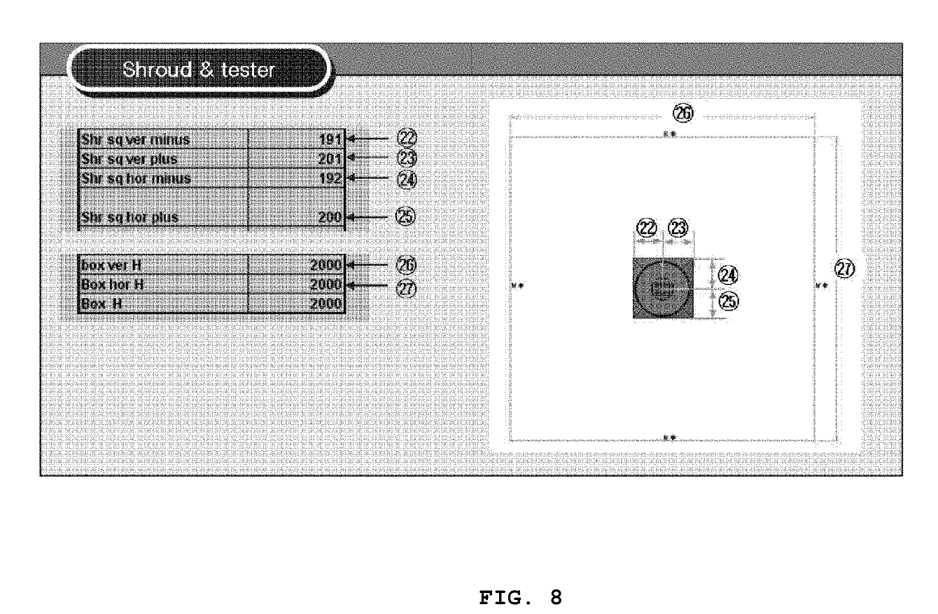

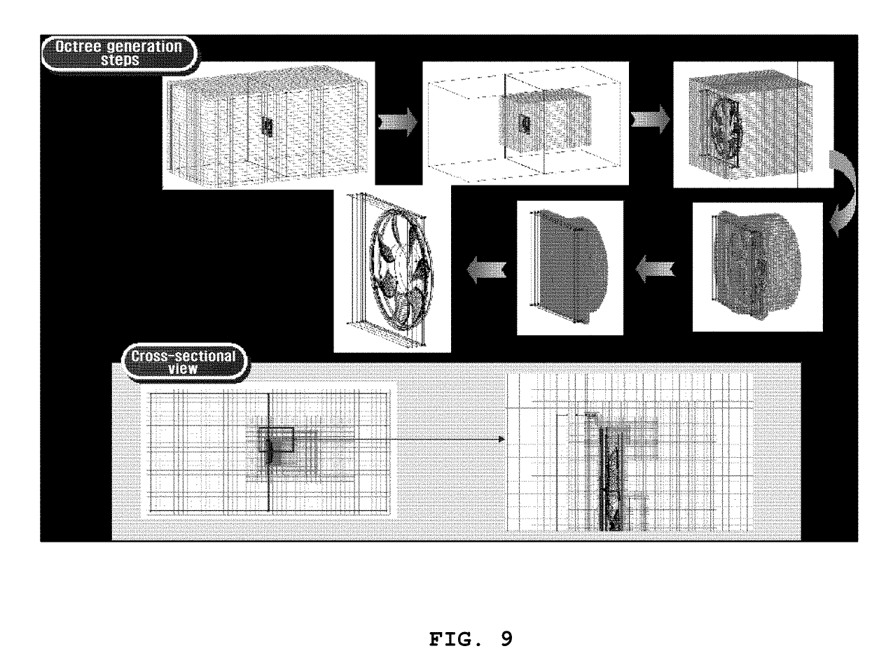

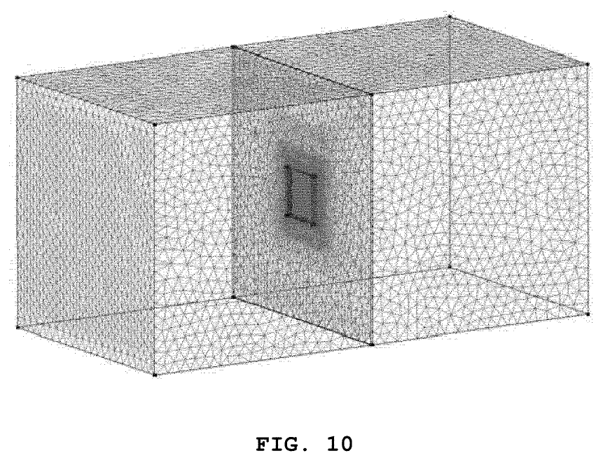

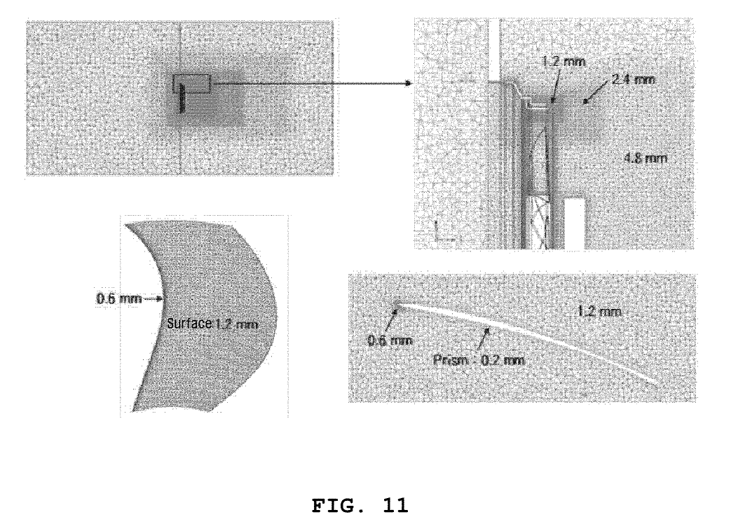

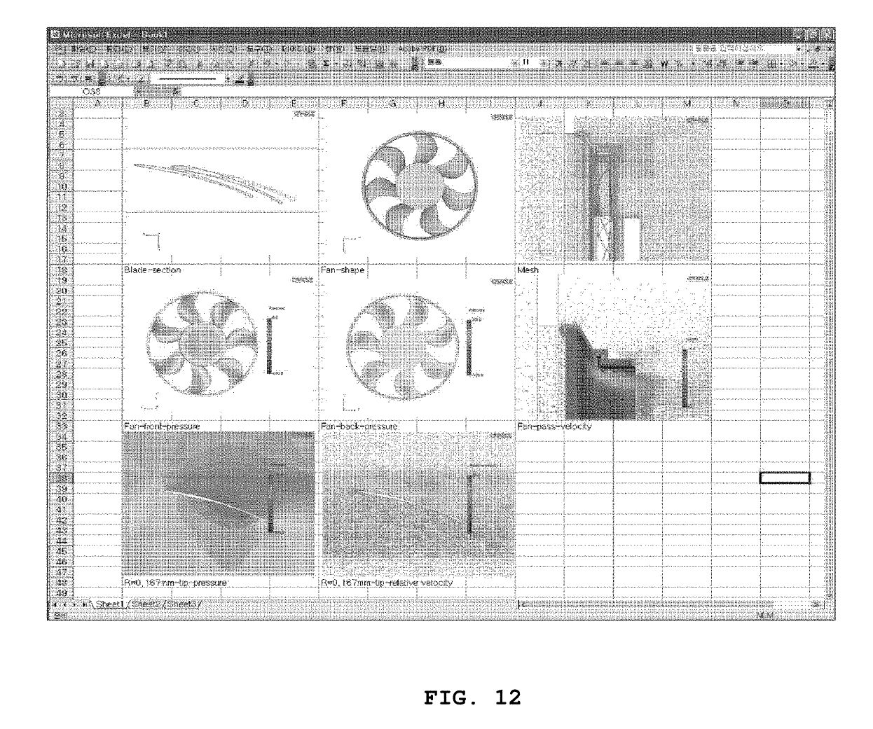

### BEST MODE

Hereinafter, exemplary embodiments of the present disclosure will be described in detail with reference to the accompanying drawings. Embodiments of the present disclosure may be modified in various types, and the scope of the present disclosure should not be interpreted to be limited to the embodiments to be described below. The embodiments of the present disclosure are intended to fully describe the present disclosure to a person having ordinary knowledge in the art to which the present disclosure pertains. Accordingly, the shapes, dimensions, etc. of components in the drawings may be exaggerated to emphasize the clearer description.

In order to carry out performance improvement research of a fan for the development of an actual product, a designer used to need not only sufficient expertise but also an anechoic wind tunnel (anechoic fan tester) which is a very expensive experimental apparatus. Furthermore, the designer used to make many mock-up products, and to repeat time-consuming measuring work. In order to replace such an inefficient and expensive research process, the present disclosure has developed a method and apparatus for a fan simulation so that a designer may easily proceed through an automated program that is built according to a special analysis process by using a CFD tool after designing a test product.

In the present disclosure, once a designer inputs point data of a fan and dimensions of a tester through a fan design module, the fan and tester are automatically made (CAD modeling) in the CAD program (CAD module). A file generated as above generates grids for the analysis by using a program. Provided the grids are generated like this, flow analysis is initiated by using boundary conditions input by a user and fundamental boundary conditions for fan analysis. On completion of the analysis, a report is automatically generated for the user to analyze the analysis result.

In the present disclosure, once a designer inputs point data and dimensions of the tester and executes the program, a CAD model of the fan and tester is automatically completed. Dimensions of a rotating zone are automatically calculated and modeled depending on the point data of the fan, and a ring and a hub are also automatically generated. In addition, in the present disclosure, a basic model for a flow work that the designer requires is provided, and, in a calculation to determine a shape of the basic model, an Euler fan turbomachinery equation and a velocity triangle, and mean line analysis are used.

Accordingly, provided the designer input only the point data of the fan and size of the tester; and dimensions of a radiator and a condenser, and distances between the shroud and the radiator and the condenser, the dimensions are automatically calculated and modeled in the program for all remaining work.

One of the most difficult parts for the designer to analyze is on grid generation. The grid is an important part for the analysis. Accordingly, accuracy of the analysis is enhanced only if the grid which is an important part for the analysis is properly generated. Consequently, sufficient experience is necessary, much time is required, and expertise on CFD is also needed for the grid generation.

In the present disclosure, an optimal condition is secured based on numerous grids generated through a grid module with respect to an axial-flow fan shape. Usually, tetra, hexa, and prism shapes are manifoldly used for grids, wherein a prism grid is used on a wall surface, a hexa grid in a large space, and a tetra grid in a space between the large space and the wall surface.

A method of generating grids in the present disclosure is to make a tetragonal cube as a whole domain and to make an important domain thereof with a small cube. Because dimensions of one small cube determine dimensions of grid for the analysis, determining the dimensions of the one small cube is most important. Particularly, for those important figurative parts such as a front surface or a rear surface of the fan, it is important to make the dimensions of the grid small and uniform by making the dimensions of the cube even smaller.

Provided a foregoing step has been performed, a model to execute the flow analysis is completed. Boundary conditions necessary for analysis should be input to execute the flow analysis (solving module). As boundary condition inputs are mostly set in optimal conditions, the designer needs to set only inlet flow, revolutions per minute (rpm) of the fan, and dt value by applying rotation angle of the fan per one cycle without dissipation for separate setting.
Input revolutions per minute of the fan.
Select pressure compensation.
Input a convergence condition: Use of an initial value is recommended.
Select turbulence model to be used for the analysis.
Setting total analysis cycle.
Time per cycle (calculate with revolutions of the fan and cycle/degree).
When IAUDT=0: dt value is used as a time interval.
Courant number: Input manually or automatically calculated when dt value is given.
Problem type: Option for steady or unsteady analysis. Usually, when a fan is analyzed, unsteady analysis follows after steady analysis that is performed to the extent of 100 cycles, whereby the analysis converges faster and proceeds more stably.
Select equation to be used for the analysis.
A window to input property of the working fluid.
Select whether the working fluid is imcompressible flow or compressible flow.

The grid is generated going through steps as above, and the analysis is executed with input boundary conditions. The analysis proceeds in the NI based supercomputer.

In order to prepare a report after completion of CFD analysis, a post-process such as drawing a figure and confirming a flow is also automatically performed (performance analysis module). The designer may judge whether the design is accomplished well or not by reviewing the figures. Furthermore, provided the design is not accomplished well, the designer may determine what is wrong with it and what is to be modified. Whether the flow passes well along a blade cross-section or a separation thereof occurs may be identified by reviewing a relative velocity at each blade cross-section. In addition, whether the fan has a good efficiency or not and whether each blade works constantly and efficiently or not may be identified by reviewing the pressure at front and rear surfaces of the blade. How the flow passing the fan flows may be identified by reviewing the distribution of the velocity and the pressure on the cross-section of the fan which is cut vertically. Accordingly, the designer may be able to obtain various kinds of information by reviewing each of the figures and develop a fan having better performance by applying the information into next design.

Meanwhile, performance analysis is accomplished on the basis of the report above. The performance analysis is performed on the basis of noise and efficiency, and flow uniformity, wherein the noise and efficiency are handled as important factors.

The noise is understood to be generated due to a pressure change, and evaluated by relative quantity through a noise index. The noise index is identified as two types, wherein one type uses (standard) deviation of pressure depending on location of the blade in a steady state and another type uses (standard) deviation of pressure depending on individual location of the blade in an abnormal state.

Through the flow analysis described above, the flow is defined by the pressure and velocity, and may be able to be defined by p=(x,y,z,t) and v=(x,y,z,t) depending on individual location (or grid) and time. At this time, time t may be disregarded, since a change of flow characteristics as time goes by is almost constant in a steady state flow, whereby the pressure and velocity may be modified as p=(x,y,z) an v=(x,y,z). Here, the (standard) deviation of the pressure depending on a change of location (x,y,z) may be identified, wherethrough the relative quantity of the noise according to data input initially may be evaluated.

Such a method may be able to drastically reduce time required for noise evaluation through simplification of the calculation by removing one variable of time t. However, the above evaluation may not be regarded as an absolute numerical value, since abnormal state flow is passed unnoticed by reflecting only a steady state flow, and optimal performance thereof is unable to be evaluated as the abnormal state flow is passed unnoticed. Accordingly, in a process of completing a design through the above performance evaluation, the steady state flow may be able to propose only a comparison criterion, and the abnormal state flow should be reflected.

With a remaining method, the (standard) deviation of the pressure depending on individual location of the blade in an abnormal state may be identified, wherethrough the relative quantity of the noise according to data input initially may be evaluated.

In addition, the efficiency is evaluated on the basis of the steady state flow and defined by the pressure multiplied by the flow divided by a torque and an angular velocity.

Although the present disclosure has been described in detail through exemplary embodiments, various types of embodiments different from the above are possible. Accordingly, a technical concept and scope of the claims described below should not be limited to the exemplary embodiments.

### INDUSTRIAL APPLICABILITY

The present disclosure may be applied to various types of a method and apparatus for a fan simulation.

What is claimed is:

1. A method for a fan simulation through flow analysis, the method comprising:
inputting necessary flow work and confirming a proposed basic design by a user;
modifying the basic design by the user;
generating a shape of the fan by calculating point data satisfying the basic design or a user input design, inputting modified dimensions of the basic design, and generating a drawing;
generating grids on the fan;
analyzing a flow generated by the fan by inputting boundary conditions for the fan; and
calculating a noise index from the analysis,
wherein, when the flow generated by the fan is in a steady state, the noise index is proportional to a pressure deviation depending on a location of the fan.

2. The method of claim 1, wherein the analyzing the flow includes calculating pressure and velocity for the flow depending on the location of the fan and time.

3. The method of claim 1, wherein, when the flow generated by the fan is in an abnormal state, the noise index is proportional to a pressure deviation at a predetermined location of the fan.

4. An apparatus for a fan simulation through flow analysis, the apparatus comprising:
a fan design module to which point data and tester dimensions are input;
a CAD module generating a shape of a fan by calculating the point data input to the fan design module, and generating a tester from the tester dimensions;
a grid module generating grids on the fan;
a solving module analyzing a flow generated by the fan by inputting boundary conditions for the fan; and
a performance analysis module calculating a noise index from the analysis,
wherein, when the flow generated by the fan is in a steady state, the performance analysis module calculates the noise index proportionately to a pressure deviation depending on a location of the fan.

5. The apparatus of claim 4, wherein the solving module calculates pressure and velocity for the flow depending on the location of the fan and time.

6. The apparatus of claim 4, wherein, when the flow generated by the fan is in an abnormal state, the performance analysis module calculates the noise index proportionately to a pressure deviation at a predetermined location of the fan.
